(19) United States
(12) Patent Application Publication
(10) Pub. No.: US 2017/0166030 A1
(43) Pub. Date: Jun. 15, 2017

(54) VEHICLE AIR-CONDITIONING APPARATUS

(71) Applicant: KASAI KOGYO CO. LTD., Koza-gun (JP)

(72) Inventors: Tadakazu NARITOMI, Setagaya-ku (JP); Tomohiro TSUIKI, Machida-shi, Tokyo (JP)

(21) Appl. No.: 15/118,456

(22) PCT Filed: Feb. 16, 2015
(86) PCT No.: PCT/JP2015/054081

§ 371 Date: Aug. 11, 2016

(30) Foreign Application Priority Data
Feb. 19, 2014 (JP) 2014-029458

(51) Int. Cl. B60H 1/00

(52) U.S. Cl. CPC B60H 1/00564; B60H 2001/00235

(57) ABSTRACT

A vehicle air-conditioning apparatus has a duct that is configured to supply an air-conditioned air to a vehicle interior, and has a resinous base layer, and an infrared reflective layer formed on a surface of the resinous base layer facing a vehicle exterior to reflect an infrared ray.

### TECHNICAL FIELD

The present invention relates to a vehicle air-conditioning apparatus, in particular, with a duct disposed between a roof and a headlining to supply an air-conditioned air into a vehicle interior.

### BACKGROUND OF THE INVENTION

Conventionally, there has been proposed a vehicle air-conditioning apparatus where a duct is disposed inside a ceiling of a vehicle interior encompassing a passenger to supply an air-conditioned air which is produced by an air-conditioning unit into the vehicle interior. For example, see Patent Document 1.

The conventional vehicle air-conditioning apparatus has a duct which is disposed between a roof panel and a headlining to guide the air-conditioned air which is produced by the air-conditioning unit into the vehicle interior, and the air-conditioned air which is supplied through the duct is supplied into the vehicle interior through an air outlet member connecting an outlet of the duct to the headlining.

However, since the duct of the conventional vehicle air-conditioning apparatus is merely formed of resin material via press-molding process or blow molding process, it is greatly influenced by external temperature, and etc.

In other words, the roof panel becomes very hot under the scorching sun of summer, and the heat which is transmitted through the roof panel warms the entire duct. At this time, the air-conditioned cool air which is supplied by the air-conditioning unit, is warmed by the heat of the warmed duct, and the air-conditioned air having a temperature which is higher than that of the air-conditioned air initially supplied by the air-conditioning unit is supplied into the vehicle interior. For the above reasons, in order to lower the temperature of the vehicle interior a load on the air-conditioning unit is accordingly increased, which leads to the deterioration of fuel efficiency.

On the other hand, the roof panel is cooled by cold air in the winter, and the cold air which is transmitted through the roof panel cools the entire duct. At this time, the air-conditioned warm air which is supplied by the air-conditioning unit, is cooled by the cold of the duct, and the air-conditioned air having a temperature which is lower than that of the air-conditioned air initially supplied by the air-conditioning unit is supplied into the vehicle interior. For the above reasons, in order to raise the temperature of the vehicle interior a load on the air-conditioning is accordingly increased, which leads to the deterioration of fuel efficiency.

### CITATION LIST

### Patent Literature

[Patent Document 1] Japanese Publication No. 2008-265445(A).

### SUMMARY OF THE INVENTION

In order to solve the afore-mentioned problems or drawbacks, the invention is to provide a vehicle air-conditioning apparatus being capable of avoiding an effect of external temperature, and etc. on the air-conditioned air which is supplied by the air-conditioning unit so as to improve air-conditioning efficiency and fuel efficiency.

In order to attain the afore-mentioned objective,

(1) The invention provides a vehicle air-conditioning apparatus, which has a duct configured to supply an air-conditioned air to a vehicle interior. The duct has a resinous base layer; and an infrared reflective layer formed on a surface of the base layer facing a vehicle exterior to reflect an infrared ray.

(2) In the vehicle air-conditioning apparatus (1), both surfaces of the base layer may be coated with the infrared reflective layer.

(3) In the vehicle air-conditioning apparatus (1) or (2), the infrared reflective layer may have a transparent base film and a metallic film vapor-deposited on at least one of front and back surfaces of the base film.

(4) In any of the vehicle air-conditioning apparatus (1)-(3), the base layer may have an urethane resinous base layer and a fibrous reinforcing layer formed on each of front and back surfaces of the urethane resinous base layer.

(5) In any of the vehicle air-conditioning apparatus (1)-(3), the base layer may have a fibrous base layer and an adhesive layer formed on at least a surface of the fibrous base layer facing the vehicle exterior.

(6) In any of the vehicle air-conditioning apparatus (1)-(5), the base layer may have an impervious film layer formed on a back surface thereof opposite to a front surface thereof facing the vehicle exterior.

According to embodiments of the invention, the vehicle air-conditioning apparatus can avoid an effect of external temperature, and etc. on the air-conditioned air which is supplied by the air-conditioning unit to improve air-conditioning efficiency and fuel efficiency.

### BRIEF DESCRIPTION OF THE DRAWINGS

FIG. 1 is a longitudinal cross-sectional view schematically showing a main part of a vehicle where a first embodiment of the vehicle air-conditioning apparatus in accordance with the invention is applied.

FIG. 2 is a schematic perspective view for illustrating an exemplary duct of the first embodiment of the vehicle air-conditioning apparatus, arranged in a ceiling of the vehicle.

FIG. 3 illustrates an operation of the first embodiment of the vehicle air-conditioning apparatus, and corresponds to a cross-sectional view of FIG. 2 along the line A-A.

FIG. 4 is an enlarged cross-sectional view of section “B” of FIG. 3.

FIG. 5 illustrates another exemplary duct of the vehicle air-conditioning apparatus.

FIG. 6 illustrates Embodiment 1 of a substrate (i.e., a base layer) for the duct of the vehicle air-conditioning apparatus.

FIG. 7 illustrates Embodiment 2 of a substrate (i.e., a base layer) for the duct of the vehicle air-conditioning apparatus.

FIG. 8 illustrates Embodiment 3 of a substrate (i.e., a base layer) for the duct of the vehicle air-conditioning apparatus.

FIG. 9 illustrates Embodiment 4 of a substrate (i.e., a base layer) for the duct of the vehicle air-conditioning apparatus.

FIG. 10 illustrate Embodiment 5 of a substrate (i.e., an infrared reflective layer) for the duct of the vehicle air-conditioning apparatus.

FIG. 11 illustrate Embodiment 6 of a substrate (i.e., an infrared reflective layer) for the duct of the vehicle air-conditioning apparatus.

FIG. 12 illustrate Embodiment 7 of a substrate (i.e., an infrared reflective layer) for the duct of the vehicle air-conditioning apparatus.

FIG. 13 is a schematic perspective view for illustrating an exemplary duct of the second embodiment of the vehicle air-conditioning apparatus, arranged in a ceiling of the vehicle.

FIG. 14 is a rough cross-sectional view of FIG. 13 along the line C-C.

FIG. 15 is an enlarged cross-sectional view of section “D” of FIG. 14.

### DETAILED DESCRIPTION OF THE INVENTION

With reference to the accompanying drawings, embodiments of the invention (hereinafter, referred to as “embodiments”) will be hereinafter described in detail. Moreover, the same reference sign is assigned to the same elements throughout the description of the embodiments.

Since a duct of a vehicle air-conditioning apparatus requires lightweight properties, it is generally formed of resinous material such as urethane resinous base material. The resinous material is subjected to press molding process or blow molding process to form the duct. A first embodiment is produced by the press molding process and a second embodiment is produced by the blow molding process.

### First Embodiment

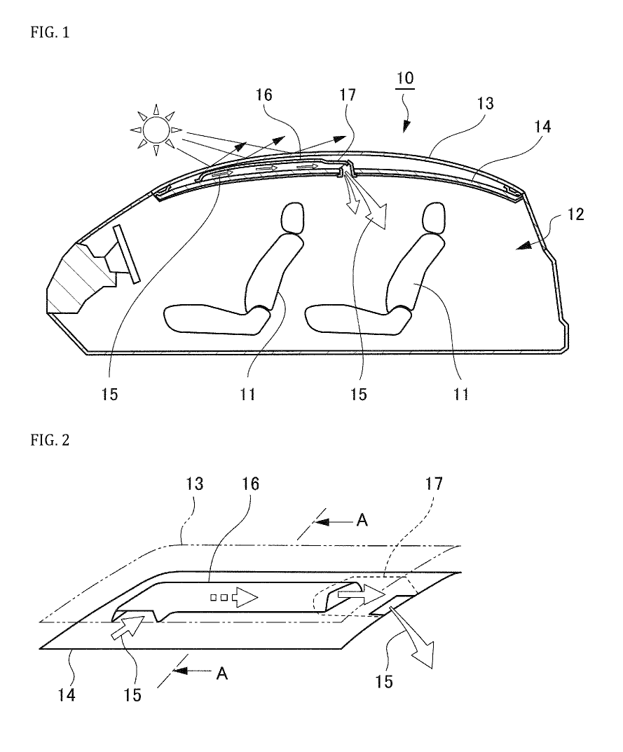

FIG. 1 is a longitudinal cross-sectional view schematically showing a main part of a vehicle where a first embodiment of the vehicle air-conditioning apparatus in accordance with the invention is applied.

A vehicle 10 as shown in FIG. 1, to which the first embodiment of the vehicle air-conditioning apparatus is applied has a vehicle interior 12 which encompasses a passenger seat 11 where a passenger has a seat. A ceiling 13 of the vehicle interior 12 has a roof panel 13 and a headlining 14 disposed below and apart from the roof panel 13. In other words, the headlining 14 is disposed at the vehicle interior 12 side.

Furthermore, the air-conditioning apparatus has an air-conditioning unit (not shown) disposed inside an engine room (not shown), and a duct 16 communicating with the air-conditioning unit and supplying an air-conditioned air 15 which is produced by the air-conditioning unit into the vehicle interior 12. The duct 16 is arranged in a space between the roof panel 13 and the headlining 14. Furthermore, an air outlet member 17 is provided at a leading end of the duct 16. The air-conditioned air 15 which is produced by the air-conditioning unit and supplied through the duct 16 is supplied through the air outlet 17 into the vehicle interior 12. While in the embodiment the duct 16 is disposed inside the ceiling of the vehicle interior 12 of the vehicle 10, it may be disposed in other location, for example, inside a door.

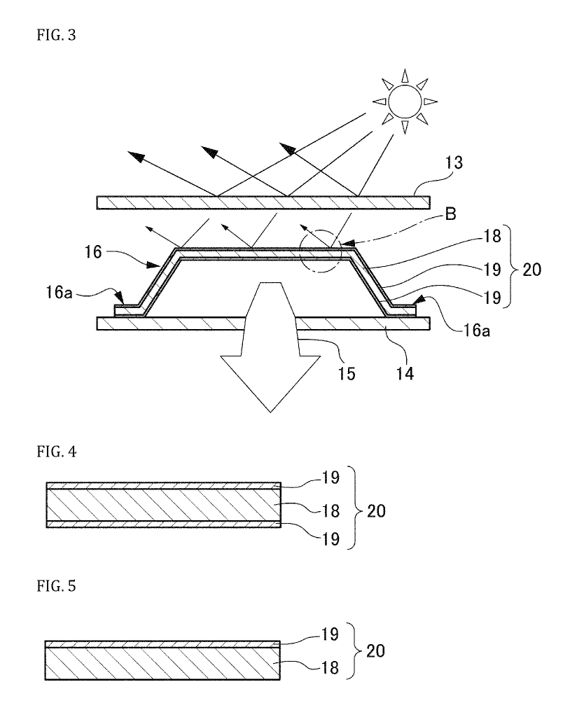

As shown in FIGS. 3 and 4, the duct 16 is approximately trapezoid-shaped in cross-section with open lower end and formed by press molding of the sheet-like substrate 20 which has a resinous base layer 18 and an infrared reflective layer 19 which can reflect an infrared ray for heat insulation and is formed on both front and back surfaces of the resinous base layer 18. Exemplary resinous base layer 18 may be urethane resin. The infrared reflective layer 19 may be formed on a single surface of the resinous base layer 18, preferably the front surface opposed to the roof panel 13. The front surface of the resinous base layer 18 opposed to the roof pane 13 corresponds to the surface of the resinous base layer 18 that faces a vehicle exterior.

The duct 16 is combined with the headlining 14 to create a space between the duct 16 and the headlining 14. The space corresponds to a passage for the air-conditioned air 15. The duct 16 is fixed at a flange portion 16a by means of hot-melt adhesive or mechanical means such as a clip, and etc.

Next, the operation of the first embodiment of the vehicle air-conditioning apparatus will be described with reference to FIG. 3.

When the roof panel 13 becomes hot under the scorching sun of summer, and the heat that is transmitted through the roof panel 13 reaches the duct 16, the infrared reflective layer 19 reflects the heat in the vehicle air-conditioning apparatus where the afore-mentioned duct 16 is disposed in the space between the roof panel 13 and the headlining 14. Accordingly, the heat having transmitted through the roof panel 13 is blocked by the infrared reflective layer 19 and is prevented from transferring into the resinous base layer 18. As such, the temperature raise in the duct 16 is mitigated. As a result, the temperature raise of the air-conditioned cool air 15 which is supplied by the air-conditioning unit is suppressed, and the air-conditioned cool air 15 can be thus supplied into the vehicle interior 12. For the reasons, the temperature of the vehicle interior 12 can be lowered without increasing the load on the air-conditioning unit, thereby enhancing fuel efficiency (electricity efficiency).

On the contrary, when the roof panel 13 that is cooled by cold air in the winter and the cold that is transmitted through the roof panel 13 reaches the duct 16, the infrared reflective layer 19 reflects the heat. Accordingly, the resinous base layer 18 is prevented from being cooled, thereby mitigating the temperature decrease in the duct 16. As a result, the temperature decrease of the air-conditioned warm air 15 which is supplied by the air-conditioning unit is suppressed, and the warm air-conditioned air can be thus supplied into the vehicle interior 12. For the reasons, the temperature of the vehicle interior 12 can be raised without increasing the load on the air-conditioning unit, thereby enhancing fuel efficiency (electricity efficiency).

Furthermore, in a case where the duct 16 is formed by respectively applying the infrared reflective layer 19 onto both of the front and the back surfaces of the resinous base layer 18, as described in this embodiment, the heat of the air-conditioned air 15 passing through the duct 16 is suppressed to transfer or spread into the resinous base layer 18. As such, the heat loss can be suppressed. As a result, the air-conditioned air 15 can be further efficiently supplied into the vehicle interior 12.

Furthermore, when implementing the first embodiment, the resinous base layer 18 and the infrared reflective layer 19 of the substrate 20 for the duct 16 can be configured in accordance with the following embodiments, alone or in combination. The configuration of the (resinous) base layers 18 is described in Embodiments 1-4, and the configuration of the infrared reflective layers 19 is described in Embodiments 5-7.

### Embodiment 1 of Substrate 20

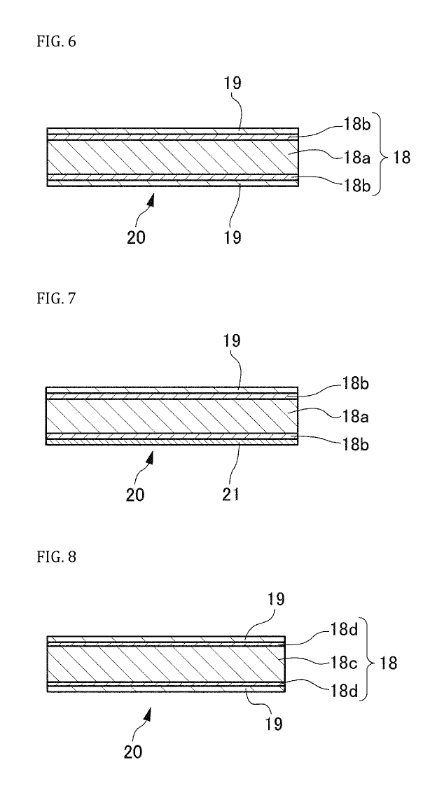

Embodiment 1 is shown in FIG. 6. The resinous base layer 18 as shown in FIG. 6 has a urethane resinous base layer 18a and a fibrous reinforcing layers 18b for reinforcing the strength of the resinous base layer 18, provided on both of front and back surfaces of the urethane resinous base layer 18a. The infrared reflective layer 19 is formed on each fibrous reinforcing layer 18b. The fibrous reinforcing layer 18b which has a fibrous material such as a glass mat is impregnated with or applied (coated) by thermosetting resin adhesive or moisture-curable adhesive such as isocyanate is formed on the urethane resinous base layer 18a.

### Embodiment 2 of Substrate 20

Embodiment 2 is shown in FIG. 7. The resinous substrate layer 18 as shown in FIG. 7 is has a urethane resinous base layer 18a and a fibrous reinforcing layers 18b for reinforcing the strength of the resinous base layer 18, provided on both front and back surfaces of the urethane resinous base layer 18a. The fibrous reinforcing layer 18b which has a fibrous material such as a glass mat is impregnated with or applied (coated) by thermosetting resin adhesive or moisture-curable adhesive such as isocyanate is respectively applied and adhered onto the urethane resinous base layer 18a, as described previously in connection with Embodiment 1. Furthermore, during the fibrous reinforcing layer 18b's adhering to the urethane resinous base layer 18a, the infrared reflective layer 19 is applied onto the surface of the fibrous reinforcing layer 18b opposed to the roof panel 13, and is fixed by the adhesive of the fibrous reinforcing layer 18b. The opposite surface (i.e., the back surface) of the urethane resinous base layer 18a has an impervious film 21 such as PET (polyethylene terephthalate) resin and PP (polypropylene) resin formed thereon. The impervious film 21 blocks aeration on the fibrous reinforcing layer 18b. The impervious film 21 is fixed by the adhesive of the fibrous reinforcing layer 18b.

### Embodiment 3 of Substrate 20

Embodiment 3 is shown in FIG. 8. The base layer 18 as shown in FIG. 8 has a fibrous base layer 18c and an adhesive layer 18d provided on both of front and back surfaces of the fibrous base layer 18c. The infrared reflective layer 19 is formed on each adhesive layer 18d. The fibrous reinforcing layer 18c which has a fibrous material such as a felt and PET that is impregnated with or applied (coated) by thermosetting resin adhesive or moisture-curable adhesive such as isocyanate is shaped into a sheet. The adhesive layer 18d is obtained by solidifying thermoplastic resin or thermosetting resin into a sheet, and is initially formed into a powder, liquid, or solid.

### Embodiment 4 of Substrate 20

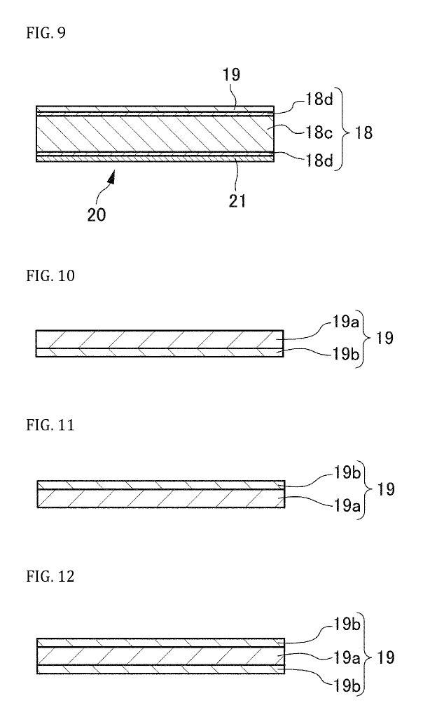

Embodiment 4 is shown in FIG. 9. The resinous base layer 18 as shown in FIG. 9 has a fibrous base layer 18c and an adhesive layer 18d provided on both of front and back surfaces of the fibrous base layer 18c, as described previously in connection with Embodiment 3. Furthermore, the infrared reflective layer 19 is applied onto the adhesive layer 18d which is formed on the front surface of the fibrous base layer 18c opposed to the roof panel 13, and is fixed by the adhesive of the adhesive layer 18d. On the other hand, as described previously in connection with Embodiment 3, an impervious film 21 such as PET (polyethylene terephthalate) resin and PP (polypropylene) resin is formed on the adhesive layer 18d which is formed on the opposite surface (i.e., the back surface) of the fibrous base layer 18c. The impervious film 21 is fixed by the adhesive of the adhesive layer 18d.

### Embodiment 5 of Infrared Reflective Layer 19

Embodiment 5 is shown in FIG. 10. The infrared reflective layer 19 as shown in FIG. 10 has a transparent, sheet-like base film 19a and a metallic film 19b formed on the base film 19a. The base film 19a may be formed of PET resin, PP resin or the like, and the metallic film 19b may be formed by for example aluminum vapor deposition. In this embodiment, the metallic film 19b is formed on the back surface of the base film 19a (i.e., the surface of the base film 19a opposed to the resinous base layer 18).

### Embodiment 6 of Infrared Reflective Layer 19

Embodiment 6 is shown in FIG. 11. The infrared reflective layer 19 as shown in FIG. 11 has a transparent, sheet-like base film 19a and a metallic film 19b formed on the base film 19a, as described previously in connection with Embodiment 5. In this embodiment (i.e., Embodiment 6), the metallic film 19b is formed on the front surface of the base film 19a (i.e., the surface of the base film 19a opposed to the roof panel 13).

### Embodiment 7 of Infrared Reflective Layer 19

Embodiment 7 is shown in FIG. 12. The infrared reflective layer 19 as shown in FIG. 12 has a transparent, sheet-like base film 19a and a metallic film 19b formed on the base film 19a, as described previously in connection with Embodiment 5 and Embodiment 6. In this embodiment (i.e., Embodiment 7), the metallic film 19b is respectively formed on both front and back surfaces of the base film 19a (i.e., the surface of the base film 19a opposed to the resinous base layer 18 and the surface of the base film 19a opposed to the roof panel 13).

Furthermore, in Embodiments 5-7, the thickness of the infrared reflective layer 19 is preferably from 0.8 micrometers to 25 micrometers, and the thickness of the metallic film 19b is preferably from 0.01 micrometers to 0.09 micrometers.

### Second Embodiment

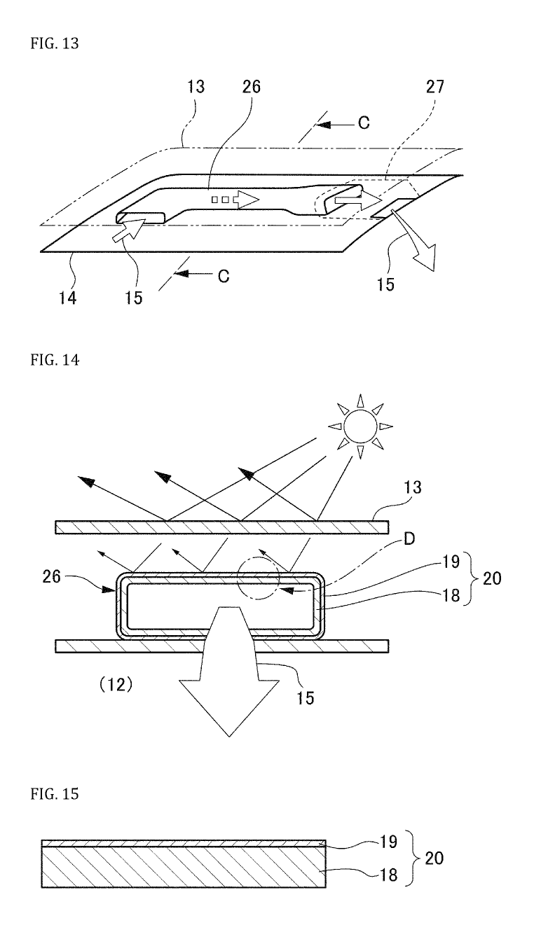

FIGS. 13-15 illustrate the second embodiment of the vehicle air-conditioning apparatus in accordance with the invention. FIG. 13 is a schematic perspective view for illustrating an exemplary duct of the second embodiment of the vehicle air-conditioning apparatus, arranged in a ceiling of the vehicle. FIG. 14 is a rough cross-sectional view of FIG. 13 along the line C-C. FIG. 15 is an enlarged cross-sectional view of section “D” of FIG. 14.

As shown in FIGS. 13 and 14, a duct 26 of the second embodiment of the vehicle air-conditioning apparatus is formed into a tube body whose cross section is a flat mouth shape (i.e., rectangular shape) by blow molding process, and disposed in the space between the roof panel 13 and the headlining 14, as described previously in connection with the duct 16 of the first embodiment. Furthermore, an air outlet member 27 is provided at a leading end of the duct 26. The air-conditioned air 15 which is produced by the air-conditioning unit and supplied through the duct 26 is supplied through the air outlet member 27 into the vehicle interior 12.

In more detail, as shown in FIGS. 14 and 15, the duct 26 is formed of the substrate 20 that has the resinous base layer 18 and the infrared reflective layer 19 for reflecting an infrared ray, provided on the front surface of the resinous base layer 18 (i.e., the surface of the resinous base layer 18 opposed to the roof panel 13).

Furthermore, the resinous base layer 18 may be formed of urethane resin, and the infrared reflective layer 19 is provided as a film sheet having the transparent base film 19a and the metallic film 19b vapor-deposited on the transparent base film 19a.

The duct 26 is fixed to the back surface of the headlining 14 through hot-melt adhesive or is mechanically fixed to a roof rail, a roof rod or the like by a clip or the like.

Next, the operation of the second embodiment of the vehicle air-conditioning apparatus will be described with reference to FIG. 14.

When the roof panel 13 becomes hot under the scorching sun of summer, and the heat that is transmitted through the roof panel 13 reaches the duct 26, the infrared reflective layer 19 reflects the heat in the vehicle air-conditioning apparatus where the afore-mentioned duct 26 is disposed in the space between the roof panel 13 and the headlining 14. Accordingly, the heat having transmitted through the roof panel 13 is blocked by the infrared reflective layer 19 and is prevented from transferring into the resinous base layer 18. As such, the temperature raise in the duct 26 is mitigated. As a result, the temperature raise of the air-conditioned cool air 15 which is supplied by the air-conditioning unit is suppressed, and the air-conditioned cool air 15 can be thus supplied into the vehicle interior 12. For the reasons, the temperature of the vehicle interior 12 can be lowered without increasing the load on the air-conditioning unit, thereby enhancing fuel efficiency (electricity efficiency).

On the contrary, when the roof panel 13 that is cooled by cold air in the winter and the cold that is transmitted through the roof panel 13 reaches the duct 26, the infrared reflective layer 19 reflects the heat. Accordingly, the resinous base layer 18 is prevented from being cooled, thereby mitigating the temperature decrease in the duct 26. As a result, the temperature decrease of the air-conditioned warm air 15 which is supplied by the air-conditioning unit is suppressed, and the warm air-conditioned air can be thus supplied into the vehicle interior 12. For the reasons, the temperature of the vehicle interior 12 can be raised without increasing the load on the air-conditioning unit, thereby enhancing fuel efficiency (electricity efficiency).

Moreover, the infrared reflective layer 19 may be respectively formed on both front and back surfaces of the resinous base layer 18. In a case where the infrared reflective layer 19 is respectively formed on both front and back surfaces of the resinous base layer 18, as described previously in the first embodiment, the heat of the air-conditioned air 15 passing through the duct 26 is suppressed to transfer or spread into the resinous base layer 18. Accordingly, the heat loss can be suppressed. As a result, the air-conditioned air 15 can be further efficiently supplied into the vehicle interior 12.

Furthermore, when implementing the second embodiment (in particular, the duct 26), the resinous base layer 18 and the infrared reflective layer 19 of the substrate 20 for the duct 26 can be configured in accordance with Embodiments 1-7 as described previously in connection with the first embodiment, alone or in combination.

Although the invention has been described with reference to the embodiments, the technical scope of the invention is not limited to the embodiments. It will be apparent to those skilled in the art that various modifications or improvements can be made to the embodiments.

### REFERENCE SIGNS LIST

10 vehicle
11 seat
12 vehicle interior
13 roof panel
14 headlining
15 air-conditioned air
16 duct
16a flange portion
17 air outlet member
18 resinous base layer
18a urethane resinous base layer
18b fibrous reinforcing layer
18c fibrous base layer
18d adhesive layer
19 infrared reflective layer
19a base film
19b metallic film
20 substrate
21 impervious film
26 duct
27 air outlet member

1. A vehicle air-conditioning apparatus, comprising:
a duct configured to supply an air-conditioned air to a vehicle interior, and comprising:
a resinous base layer; and
an infrared reflective layer configured to reflect an infrared ray,
wherein a surface of the base layer facing a vehicle exterior is coated with the infrared reflective layer.

2. The vehicle air-conditioning apparatus in accordance with claim 1, wherein both surfaces of the base layer are coated with the infrared reflective layer.

3. The vehicle air-conditioning apparatus in accordance with claim 1, wherein the infrared reflective layer comprises a transparent base film and a metallic film vapor-deposited on at least one of front and back surfaces of the base film.

4. The vehicle air-conditioning apparatus in accordance with claim 1, wherein the base layer comprises an urethane resinous base layer and a fibrous reinforcing layer formed on each of front and back surfaces of the urethane resinous base layer.

5. The vehicle air-conditioning apparatus in accordance with claim 1, wherein the base layer comprises a fibrous base layer and an adhesive layer formed on at least a surface of the fibrous base layer facing the vehicle exterior.

6. The vehicle air-conditioning apparatus in accordance with claim 1, wherein the base layer comprises an impervious film layer formed on a back surface thereof opposite to a front surface thereof facing the vehicle exterior.
